(19) United States
(12) Patent Application Publication
(10) Pub. No.: US 2004/0140251 A1
(43) Pub. Date: Jul. 22, 2004

(54) Ultraviolet cleaning water device

(76) Inventor: Chih-Ling Hsiao, Taichung (TW)

Correspondence Address: Chih-Ling Hsiao, 58, MA YUAN WEST ST.,, TAICHUNG, TW

(21) Appl. No.: 10/350,382

(22) Filed: Jan. 21, 2003

(51) Int. Cl. B01D 1/00

(52) U.S. Cl. 210/149; 210/192; 422/186.3

(57) ABSTRACT

An ultraviolet cleaning water device has a cleaning water cylinder, a temperature sensor device, an ultraviolet ray tube inserted in the cleaning water cylinder, a plurality of tube pins disposed on a bottom of the ultraviolet ray tube, a socket connected to the bottom of the ultraviolet ray tube, a power source device, a stabilizer, a cable connected to the power source device and the stabilizer, a wire connected to the power source device and the temperature sensor device, and a plurality of conductive pins connected to the power source device and the socket to communicate with the tube pins. The cleaning water cylinder has a channel to receive the temperature sensor device.

### BACKGROUND OF THE INVENTION

The present invention relates to an ultraviolet cleaning water device. More particularly, the present invention relates to an ultraviolet cleaning water device which has a temperature sensor device to detect a temperature of a cleaning water cylinder in order to control a stabilizer to turn off a power source device while the temperature of the cleaning water cylinder is too high.

Referring to FIG. 4, a conventional ultraviolet cleaning water device has a cleaning water cylinder 1′ and an ultraviolet ray tube 12′ inserted in the cleaning water cylinder 1′. When water flows through the cleaning water cylinder 1′, the ultraviolet ray tube 12′ will produce ultraviolet ray tube 12′ to kill bacteria in the water. However, the ultraviolet ray tube 12′ is often operated all the day. When the water flows through the cleaning water cylinder 1′, a temperature of the cleaning water cylinder 1′ will not be increased significantly. When the water does not flow, the ultraviolet ray tube 12′ will increase the temperature of the cleaning water cylinder 1′ significantly. Therefore, a temperature of the water will be increased significantly so that the high temperature water may burn a user.

### SUMMARY OF THE INVENTION

An object of the present invention is to provide an ultraviolet cleaning water device which has a temperature sensor device to detect a temperature of a cleaning water cylinder in order to control a stabilizer to turn off a power source device while the temperature of the cleaning water cylinder is too high. Therefore, a temperature of water will not be too high while the water does not flow.

Accordingly, an ultraviolet cleaning water device comprises a cleaning water cylinder, a temperature sensor device, an ultraviolet ray tube inserted in the cleaning water cylinder, a plurality of tube pins disposed on a bottom of the ultraviolet ray tube, a socket connected to the bottom of the ultraviolet ray tube, a power source device, a stabilizer, a cable connected to the power source device and the stabilizer, a wire connected to the power source device and the temperature sensor device, and a plurality of conductive pins connected to the power source device and the socket to communicate with the tube pins. The cleaning water cylinder has a channel to receive the temperature sensor device.

### BRIEF DESCRIPTION OF THE DRAWINGS

FIG. 1 is a perspective exploded view of an ultraviolet cleaning water device of a preferred embodiment in accordance with the present invention;

FIG. 2 is a perspective assembly view of an ultraviolet cleaning water device of a preferred embodiment in accordance with the present invention;

FIG. 3 is a scematic view illustrating an application of an ultraviolet cleaning water device of a preferred embodiment in accordance with the present invention; and

FIG. 4 is a perspective view of a conventional ultraviolet cleaning water device of the prior art.

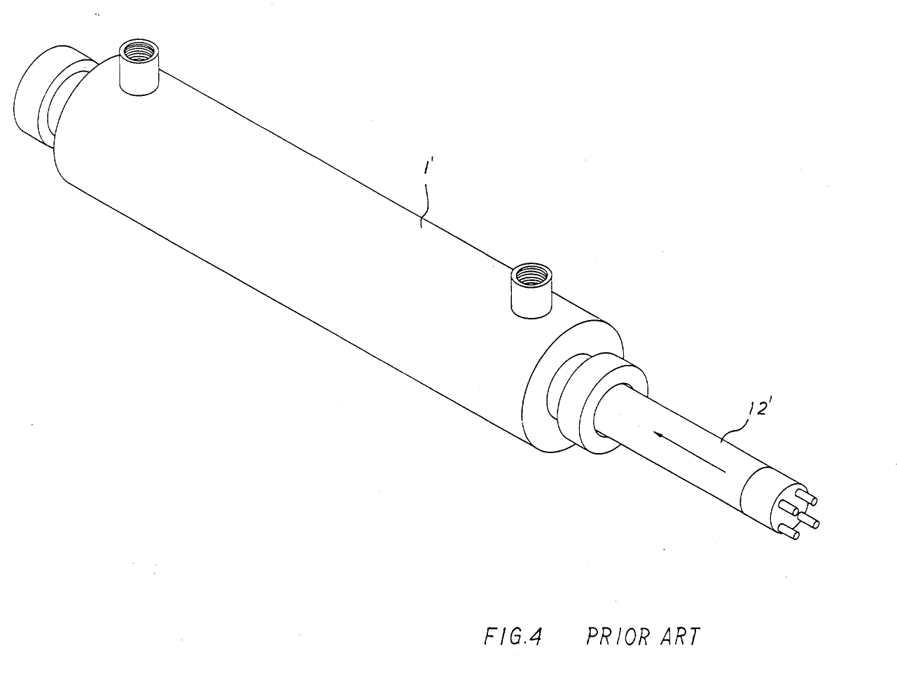

### DETAILED DESCRIPTION OF THE INVENTION

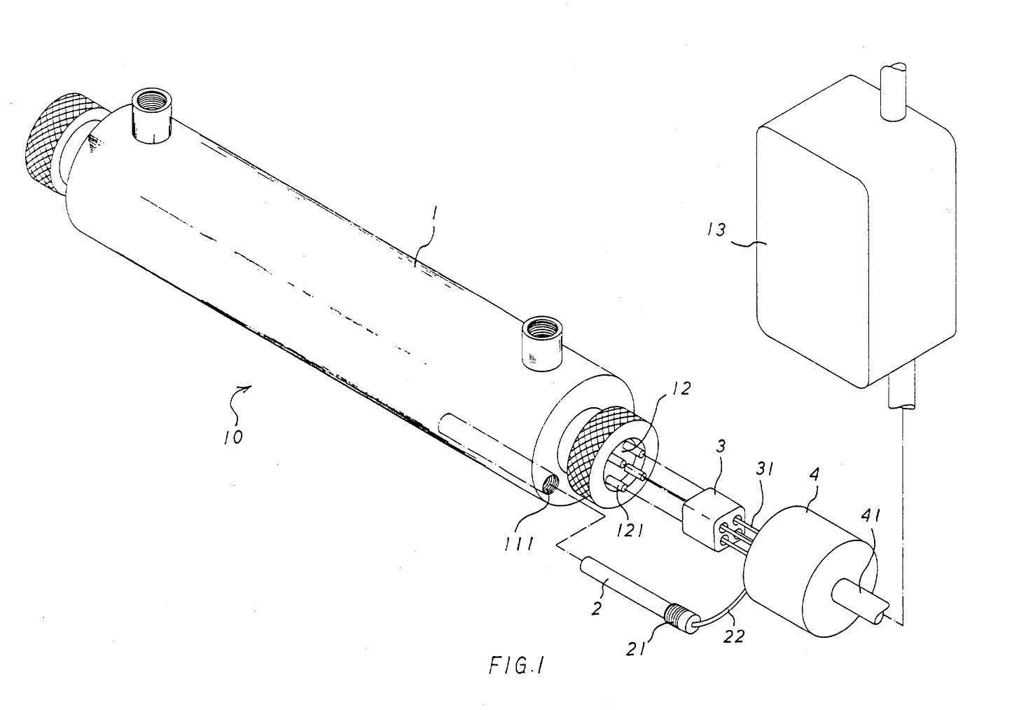

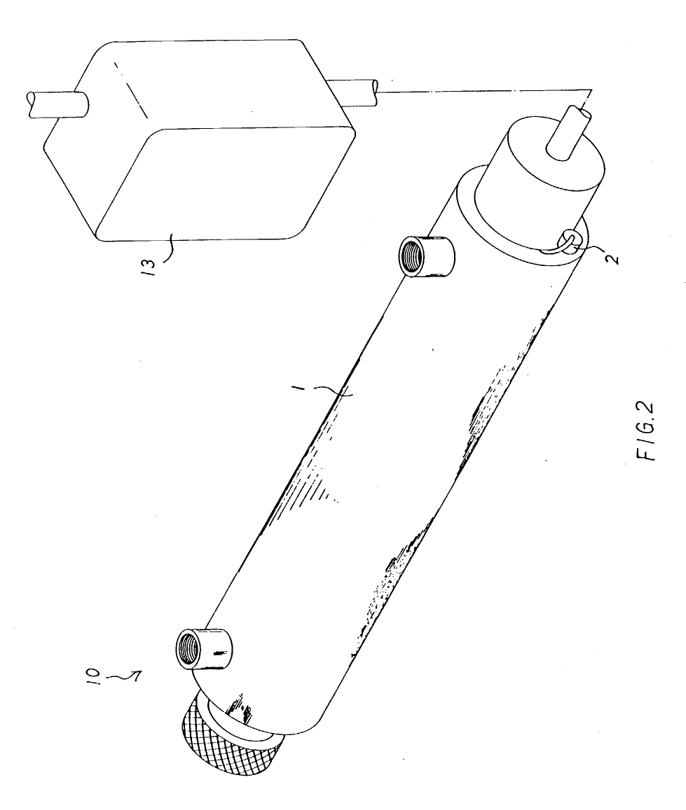

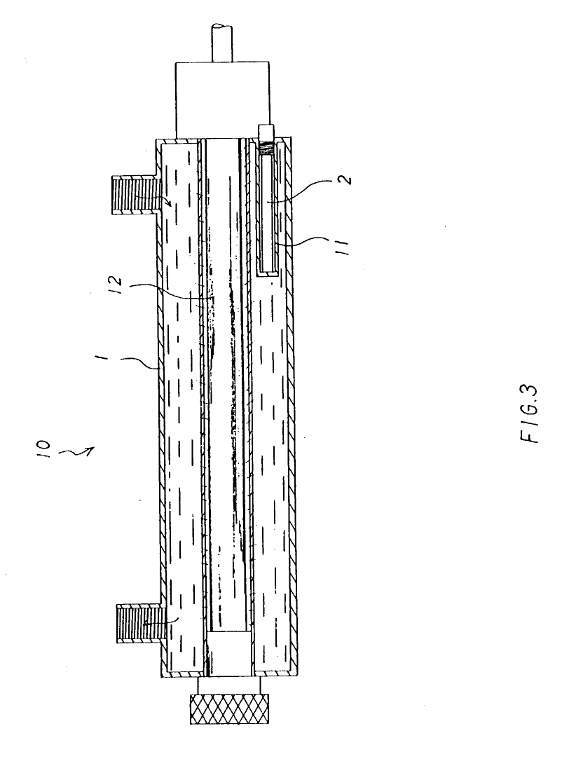

Referring to FIGS. 1 to 3, an ultraviolet cleaning water device 10 comprises a cleaning water cylinder 1, a temperature sensor device 2, an ultraviolet ray tube 12 inserted in the cleaning water cylinder 1, a plurality of tube pins 121 disposed on a bottom of the ultraviolet ray tube 12, a socket 3 connected to the bottom of the ultraviolet ray tube 12, a power source device 4, a stabilizer 13, a cable 41 connected to the power source device 4 and the stabilizer 13, a wire 22 connected to the power source device 4 and the temperature sensor device 2, and a plurality of conductive pins 31 connected to the power source device 4 and the socket 3 to communicate with the tube pins 121.

The cleaning water cylinder 1 has a channel 11 to receive the temperature sensor device 2.

The temperature sensor device 2 has an outer thread 21.

The channel 11 of the cleaning water cylinder 1 has an inner thread 111 to engage with the outer thread 21 of the temperature sensor device 2.

When the temperature sensor device 2 detects a temperature of the cleaning water cylinder 1 reaches a predetermined temperature, the temperature sensor device 2 controls the stabilizer 13 to turn off the power source device 4.

When the temperature sensor device 2 detects a temperature of the cleaning water cylinder 1 is too low, the temperature sensor device 2 controls the stabilizer 13 to turn on the power source device 4.

The invention is not limited to the above embodiment but various modification thereof may be made. Further, various changes in form and detail may be made without departing from the scope of the invention.

I claim:

1. An ultraviolet cleaning water device comprises:
a cleaning water cylinder, a temperature sensor device, an ultraviolet ray tube inserted in the cleaning water cylinder, a plurality of tube pins disposed on a bottom of the ultraviolet ray tube, a socket connected to the bottom of the ultraviolet ray tube, a power source device, a stabilizer, a cable connected to the power source device and the stabilizer, a wire connected to the power source device and the temperature sensor device, and a plurality of conductive pins connected to the power source device and the socket to communicate with the tube pins,
the cleaning water cylinder having a channel to receive the temperature sensor device, and
when the temperature sensor device detects a temperature of the cleaning water cylinder reaches a predetermined temperature, the temperature sensor device controls the stabilizer to turn off the power source device.

2. The ultraviolet cleaning water device as claimed in claim 1, wherein the temperature sensor device has an outer thread.

3. The ultraviolet cleaning water device as claimed in claim 2, wherein the channel of the cleaning water cylinder has an inner thread to engage with the outer thread of the temperature sensor device.
